(19) United States
(12) Patent Application Publication
(10) Pub. No.: US 2021/0298269 A1
(43) Pub. Date: Sep. 30, 2021

(54) PET DRINKING FOUNTAIN

(71) Applicant: Russell Lee Caldwell, Garden Prairie, IL (US)

(72) Inventor: Russell Lee Caldwell, Garden Prairie, IL (US)

(21) Appl. No.: 16/833,866

(22) Filed: Mar. 30, 2020

(51) Int. Cl. A01K 7/02; A01K 13/00

(52) U.S. Cl. CPC A01K 7/027; A01K 13/001

(57) ABSTRACT

A pet service structure includes a housing including a floor, upstanding sidewalls, a ceiling, and water piping connectable to a water source. A pet fountain is disposed outside of the housing. The pet fountain includes a frame coupled to one of the sidewalls, a bowl coupled to the frame and disposed near a ground level, a water spout connected to the water piping and directed towards the bowl, and a valve configured to open and close the water spout.

### BACKGROUND OF THE INVENTION

The present invention relates to outdoor drinking fountains and, more particularly, to a pet outdoor drinking fountain.

A drinking fountain, also called a water fountain, is a fountain designed to provide drinking water. The fountain includes of a basin with either continuously running water or a tap. Outdoor pet drinking fountains typically include a bowl lower to the ground to be accessed by pets. In colder climates, the water pipes of the outdoor pet drinking fountain freezes and is thereby unable to be used.

As can be seen, there is a need for an outdoor pet drinking fountain that does not freeze.

### SUMMARY OF THE INVENTION

In one aspect of the present invention, a pet service structure comprises: a housing comprising a floor, upstanding sidewalls, a ceiling, and water piping connectable to a water source; and a pet fountain disposed outside of the housing and comprising a frame coupled to one of the sidewalls, a bowl coupled to the frame and disposed near a ground level, a water spout connected to the water piping and directed towards the bowl, and a valve configured to open and close the water spout.

In another aspect of the present invention, a pet water fountain comprises: a frame; a heating element coupled within the frame; a water piping coupled within the frame and in communication with the heating element; a bowl coupled to the frame; a water spout connected to the frame and the water piping, wherein the water spout is directed towards the bowl; and a valve configured to open and close the water spout, wherein the heating element is configured to heat the water piping.

These and other features, aspects and advantages of the present invention will become better understood with reference to the following drawings, description and claims.

### BRIEF DESCRIPTION OF THE DRAWINGS

FIG. 1A is a perspective view of an embodiment of the present invention;

FIG. 1B is a perspective view of an embodiment of the present invention;

FIG. 2 is a perspective view of an embodiment of the present invention installed outside of a structure; and

FIG. 3 is detail perspective view of an embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a pet drinking fountain incorporated into a pet wash vending unit. The pet drinking fountain is incorporated into the pet wash unit using an existing water hook-up and the top, sides and back are exposed to a heat source to prevent water from freezing in cold climates.

The pet drinking fountain includes a frame with a valve, a water spout, and water hosing. The structure, such as a pet wash vending unit, contains the frame. A button may control the valve so that when engaged, water is delivered from the spout and into the bowl. The bowl has a small hole in the bottom to allow it to drain until empty.

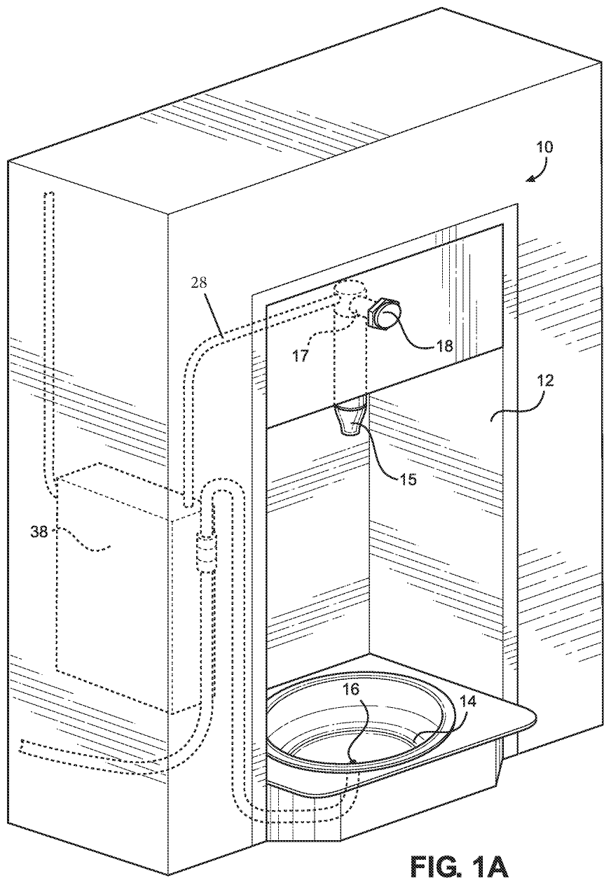

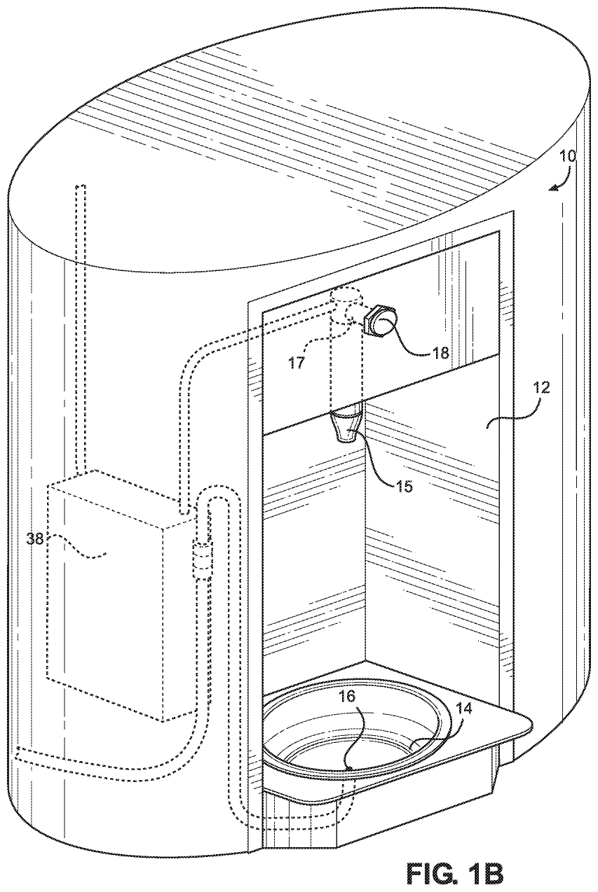

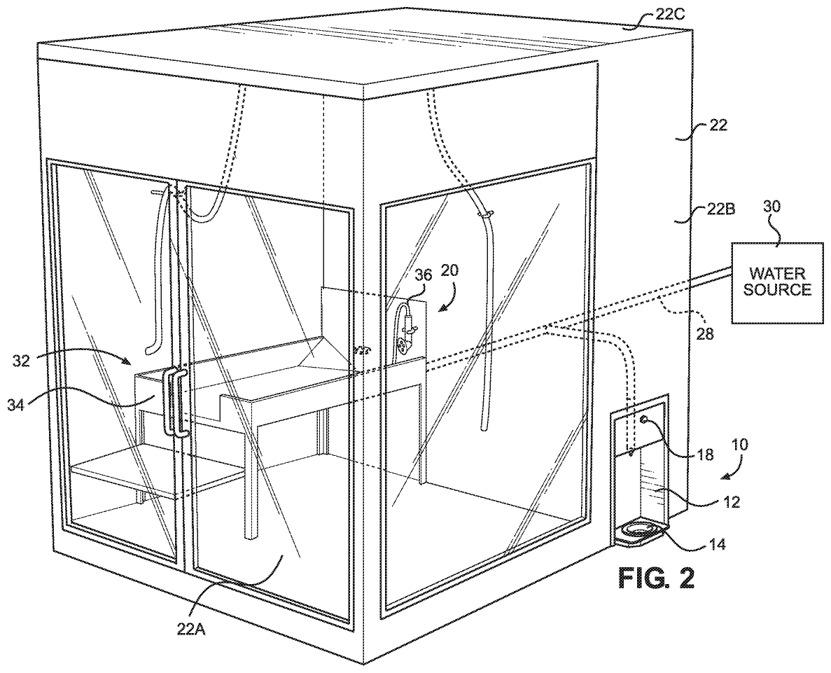

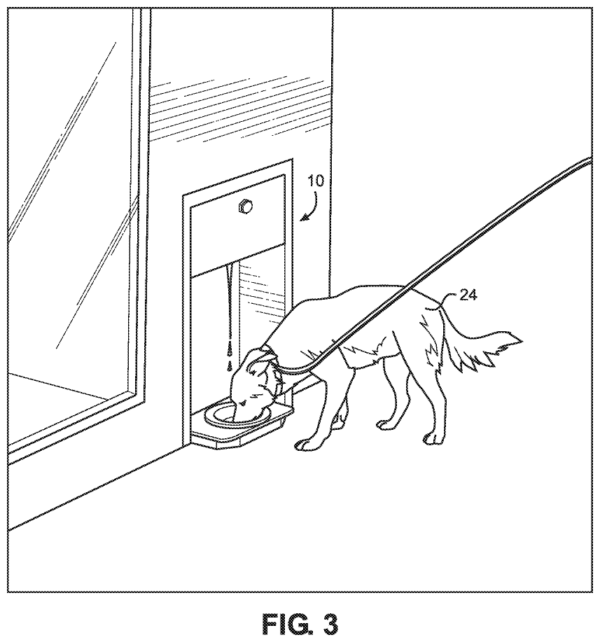

Referring to FIGS. 1A through 3, the present invention includes a pet service structure. The pet service structure includes a housing 22 including a floor 22a, upstanding sidewalls 22b, a ceiling 22c, and water piping 28 connectable to a water source 30. A pet fountain 10 is disposed outside of the housing 22. The pet fountain 10 includes a frame 12 coupled to one of the sidewalls 22b, a bowl 14 coupled to the frame 12 and disposed near a ground level, a water spout 15 connected to the water piping 28 and directed towards the bowl 14, and a valve 17 configured to open and close the water spout 15.

The housing 22 may include any structure with insulated walls, a heating, ventilation, and air conditioning (HVAC) system, and water piping 28. In certain embodiments, the housing 22 is a structure used for pet maintenance. For example, a pet bath 32 is disposed inside of the housing 22. The pet bath 32 includes a tub 34 and a hose 36. The hose 36 is coupled to the water piping 28.

The frame 12 includes a base, sidewalls walls upstanding from the base with an open front, and top portion. The frame 12 may be made out of metal. The bowl 14 is coupled to the base and the waterspout 15 is coupled to the top and disposed over the bowl 14. The bowl 14 may include a drain hole at the bottom which allows unused drinking water to drain out, leaving the bowl 14 empty, so water does not freeze or stagnate. The sidewall 22 may include a cutout portion. The frame 12 is coupled within the cutout portion so that the pet fountain 10 is inset with the housing 22. Exposing the top, sidewalls, and base of the frame 12 to the heat source of the housing 22 prevents freezing which allows the pet fountain 10 to remain operational during cold weather.

In certain embodiments, the pet fountain 10 further includes a push button 18 coupled to the top portion of the frame 12 and operable to open and close the valve 17. User may bring their pet 24 to take a bath within the housing 22 or have a drink by pressing the button 18 of the pet fountain 10.

As illustrated in FIGS. 1A and 1B, the present may include a stand-alone pet fountain 10. The stand-alone pet fountain 10 is detached from other structures. The stand-alone pet fountain includes a frame 12 and a heating element 38 coupled within the frame 12. The heating elements 38 may include heated coils, or other heating device powered by an external power source or by an internal battery. A water piping 28 is coupled within the frame 12 and in communication with the heating element 38. The bowl 14 is coupled to the frame. The bowl 14 may include a drain 16 which leads to piping for recycling the water. A waterspout 15 is connected to the frame 12 and the water piping 28. The waterspout 15 is directed towards the bowl 14. A valve 17 is configured to open and close the waterspout 15 via a button 18. The heating element 38 is configured to heat the water piping 28 and prevent the water piping 28 from freezing.

It should be understood, of course, that the foregoing relates to exemplary embodiments of the invention and that modifications may be made without departing from the spirit and scope of the invention as set forth in the following claims.

What is claimed is:

1. A pet service structure comprising:
a housing comprising a floor, upstanding sidewalls, a ceiling, and water piping connectable to a water source; and
a pet fountain disposed outside of the housing and comprising a frame coupled to one of the sidewalls, a bowl coupled to the frame and disposed near a ground level, a water spout connected to the water piping and directed towards the bowl, and a valve configured to open and close the water spout.

2. The pet service structure of claim 1, further comprising a pet bath disposed inside of the housing, the pet bath comprising a tub and a hose, wherein the hose is coupled to the water piping

3. The pet service structure of claim 1, wherein the one of the sidewalls comprises a cut out portion and the frame is coupled within the cutout portion so that the pet fountain is inset with the housing.

4. The pet service structure of claim 1, wherein the frame comprises a base, sidewalls walls upstanding from the base with an open front, and top portion, wherein the bowl is coupled to the base and the water spout is coupled to the top and disposed over the bowl.

5. The pet service structure of claim 4, wherein the pet fountain further comprises a push button coupled to the top portion of the frame and operable to open and close the valve.

6. A pet water fountain comprising:
a frame;
a heating element coupled within the frame;
a water piping coupled within the frame and in communication with the heating element;
a bowl coupled to the frame;
a water spout connected to the frame and the water piping, wherein the water spout is directed towards the bowl; and
a valve configured to open and close the water spout, wherein
the heating element is configured to heat the water piping.

7. The pet water fountain of claim 6, wherein the frame comprises a base, sidewalls walls upstanding from the base with an open front, and top portion, wherein the bowl is coupled to the base and the water spout is coupled to the top and disposed over the bowl.

8. The pet water fountain of claim 6, wherein the pet fountain further comprises a push button coupled to the top portion of the frame and operable to open and close the valve.
